(19) United States
(12) Patent Application Publication
(10) Pub. No.: US 2018/0304351 A1
(43) Pub. Date: Oct. 25, 2018

(54) Stopper for a Sprue of a Casting Mould

(71) Applicant: Udo Tartler, Lutzelbach/Haingrund (DE)

(72) Inventor: Udo Tartler, Lutzelbach/Haingrund (DE)

(21) Appl. No.: 15/921,494

(22) Filed: Mar. 14, 2018

Related U.S. Application Data
(63) Continuation of application No. 14/371,413, filed on Jul. 9, 2014, now abandoned.

(30) Foreign Application Priority Data
Jan. 11, 2012 (DE) 102012000354.4

(51) Int. Cl. B22D 17/22; B29C 45/23; B29C 33/00; B29C 33/40

(52) U.S. Cl. CPC B22D 17/2281; B29C 45/234; B29C 33/40; B29C 45/232; B29C 33/0077

(57) ABSTRACT

The invention relates to a stopper for a sprue of a casting mould, said stopper having a through-passage for introducing casting material into the sprue of the casting mould and being designed such that it automatically closes the through-passage to prevent casting material from flowing out of the casting mould, and also to a method for filling a casting mould with casting material, having the steps of: inserting such a stopper into a sprue of a casting mould and introducing casting material into the through-passage.

The present invention relates to a stopper for a sprue of a casting mould and a method for its use.

### BACKGROUND

Historically, the so-called sprues were first always oriented in casting moulds so that these pour-in openings led from the top into the casting mould so that casting material, such as bronze or later cast iron, could be poured from above into the casting mould by means of crucibles and then remained in the mould in liquid form until solidification. Moreover, the invention and development of plastic changed the technology of casting. Variants were developed, in which the liquid or paste-like, i.e. higher viscous casting material, is directed into the sprue through feed lines without free fall (as was the case with historical “casting”). Injection moulding, in which the casting material is introduced into the sprue of the casting mould under particularly high pressure by an injection moulding machine, is just one particularly well-known example of many. Another example is the introduction of plastic through a feed line into the sprue of any mould (casting mould), wherein the plastic is made of at least two liquid components. These are mixed together in a suitable mixing device before introduction so that the resulting liquid or paste-like mixture is polymerised and “hardens” in the casting mould. The feed line to be connected for introduction to the sprue is then commonly a tubular structure (mixer) with mould elements on the inside, which divert and thus mix casting material flowing through it. Hose lines, in the same number as the number of components being mixed together to create the plastic, commonly lead into this mixer. The mixing of the components is thus ensured as late as possible before introduction into the casting mould. This also enables the use of plastic with a short “pot life”, which already polymerises a short period after the mixing and loses flowability (viscosity).

When a feed line connects to the sprue in a sealed manner, the orientation of the sprues from above into the casting moulds is logically not required, because the seal prevents the fed casting material from flowing back to the outside in any case.

However, after introduction of the casting material into a casting mould, the feed line should be disconnected from the sprue as soon as possible in order to have it available again for example for a next feeding procedure.

The flowing of casting material that has not yet hardened out of the casting mould, which can happen in particular after the introduction of casting material when the feed line is removed and the sprue is thus open, is in turn disadvantageous due to the contamination and material loss that is causes.

### SUMMARY OF THE INVENTION

The object of the present invention is to create a casting method as well as an aid for it in order to optimize the efficiency of the casting method.

This object is solved by a stopper having the features of claim 1 and by a method having the features of claim 10. Preferred embodiments are specified in the dependent claims.

The invention relates to a stopper for a sprue of a casting mould, said stopper having a through-passage for introducing casting material into the sprue of the casting mould. According to the invention, this stopper is further designed so that it automatically closes the through-passage so that casting material does not flow back out of the casting mould. For example, this stopper is designed such that it automatically closes when there is a pressure difference between the interior of the casting mould and a surrounding area of the casting mould, which pushes the casting material out of the sprue.

This automatic closing to prevent an outflow from the casting mould avoids contamination and material loss in particular after the introduction of casting material, which would be caused by the outflow of casting material that has not yet hardened, namely as soon as for example a feed line first sealing the sprue is removed from the sprue. For example, when the sprue is not oriented from above into the casting moulds but rather laterally or from below, the stopper according to the invention prevents the casting material from flowing out due to gravitational force—but continues to enable the introduction of the casting material because it only closes automatically against the outflow.

Thus, according to the invention, the feed line can advantageously be immediately disconnected from the sprue, which is provided with the stopper according to the invention, after the introduction of the casting material into the casting mould in order to have it available again for example for a next feeding procedure.

In order to facilitate the connection of a feed line for the casting material, the stopper can have a connection profile, which is designed to connect a casting material feed line. This profile is preferably arranged on a side of the stopper pointing towards the outside of the casting mould when it is inserted into a casting mould, and particularly preferably in the through-passage. There, grooves progressing circumferentially radially can be designed for example complementary to webs progressing circumferentially radially on a thus suitably designed tip of a mixer, which then systematically fits with this connection profile.

For insertion into the sprue of a casting mould, the stopper preferably has an installation device, by means of which the stopper can be releasably fastened in the sprue of the casting mould. The casting mould, for the sprue of which the stopper according to the invention is provided, can also have structures through which it is adjusted for the insertion.

The design of the stopper according to the invention such that it automatically closes the through-passage against flow of casting material back out of the casting mould is achieved according to the invention for example and preferably in that the stopper has a stopper body made of an elastic material, in particular an elastomer such as EPDM or Vulkollan® from Bayer®, which deforms elastically under the pressure of the casting material during introduction through the through-passage into the sprue of the casting mould and thereby opens a closure in the through-passage into the sprue, while the closure is closed in the case of an undeformed body. For this, the closure preferably has one or more slits, the walls of which lie on top of each other in the undeformed state of the stopper body and close the through-passage. But other “check valve types” such as ball valves are also practical and realisable according to the invention.

The slit is preferably straight, but it can also be jagged or wavy. Several slits are preferably rotated towards each other around an (imaginary) axis by the same angle.

The invention also relates to a method for filling a casting mould with casting material. In the case of this method, a stopper of the type described up until now according to the invention is inserted into a sprue of a casting mould and casting material is then introduced into the through-passage.

### BRIEF DESCRIPTION OF THE FIGURES

These and additional advantages and features of the invention are described in greater detail below based on the following illustrations of exemplary embodiments of the invention. They show in:

FIG. 1 a spatial view of a stopper according to the invention,

FIG. 2 a side view of the stopper according to FIG. 1,

FIG. 3 the side view of the stopper according to FIG. 2 cut,

FIG. 4 the cut side view of the stopper according to FIG. 3 inserted into the sprue of a casting mould,

FIG. 5 a cut spatial view of the arrangement according to FIG. 4 in a view from outside the casting mould, and

FIG. 6 another cut spatial view of the arrangement according to FIG. 4 in a view opposite that in FIG. 5 from within the casting mould.

All figures show a stopper 2 for a sprue 4 in a sectional plane 5 of a casting mould 6 (FIGS. 4 to 6). Only a cone-shaped partial volume 6 is visible from the casting mould 6 (shown cut).

### DETAILED DESCRIPTION OF THE INVENTION

The stopper 2 has a through-passage 8 for introducing casting material (not shown) into the sprue 4 of the casting mould 6. The stopper 2 is designed in a rotationally symmetrical manner around the axis 9.

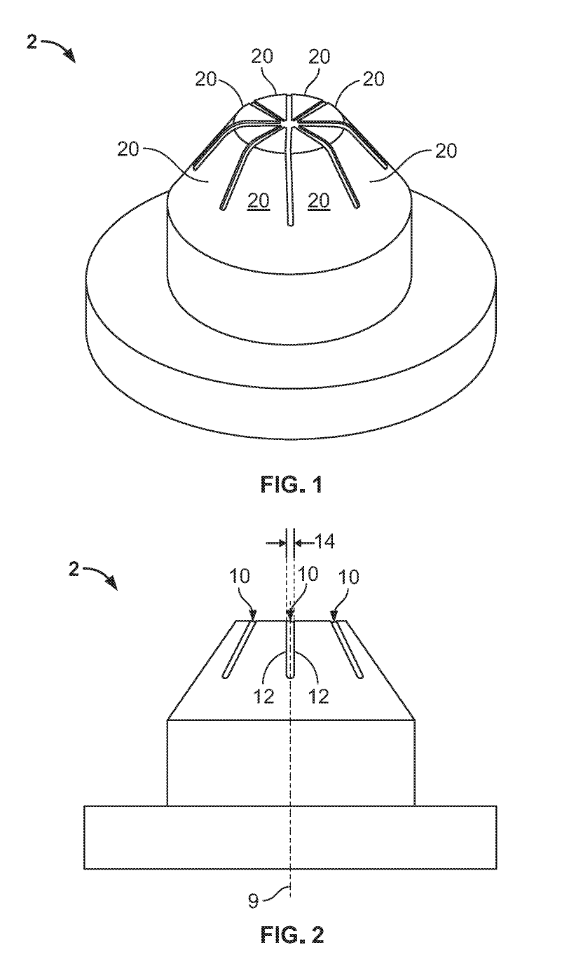

According to the invention, this stopper 2 is designed so that it automatically closes the through-passage 8 so that casting material does not flow back out of the casting mould. For this, the stopper 2 consists of a stopper body 2 made of an elastic material, which deforms elastically (not shown) under the pressure of the casting material (not shown) during introduction through the through-passage 8 into the sprue 4 of the casting mould 6 (FIG. 4) and thereby opens a closure 10 in the through-passage 8, while the closure 10 is closed in the case of an undeformed body. For this, the closure has four slits 10 (FIG. 1), the walls 12 (FIG. 2) of which lie on each other in the undeformed state of the stopper body 2 (the figures show the slits 10 with a certain width 14 for the detectability of the walls 12) and close the through-passage 8. The slits 10 are straight and turned towards each other around the symmetrical axis 9 of the stopper 2 by 45°.

In the undeformed state of the stopper body (in accordance with all figures), all four slits 10 extend radially with respect to the direction of flow 9 (identical to the symmetrical axis 9) through the end 18 of the stopper body 2, which protrudes into the casting mould 6 (FIG. 4) and into which the through-passage flows in the direction of the casting mould 6 (FIG. 4), and axially from the end 18 into the through-passage 8.

Under the pressure of an introduced casting material (not shown), the eight pie-shaped ends 20 (FIG. 1), into which the four slits 10 divide the end 18, spread radially outward and thus now release the through-passage 8 over the entire length of the stopper 2 in the area of the central symmetrical axis 9.

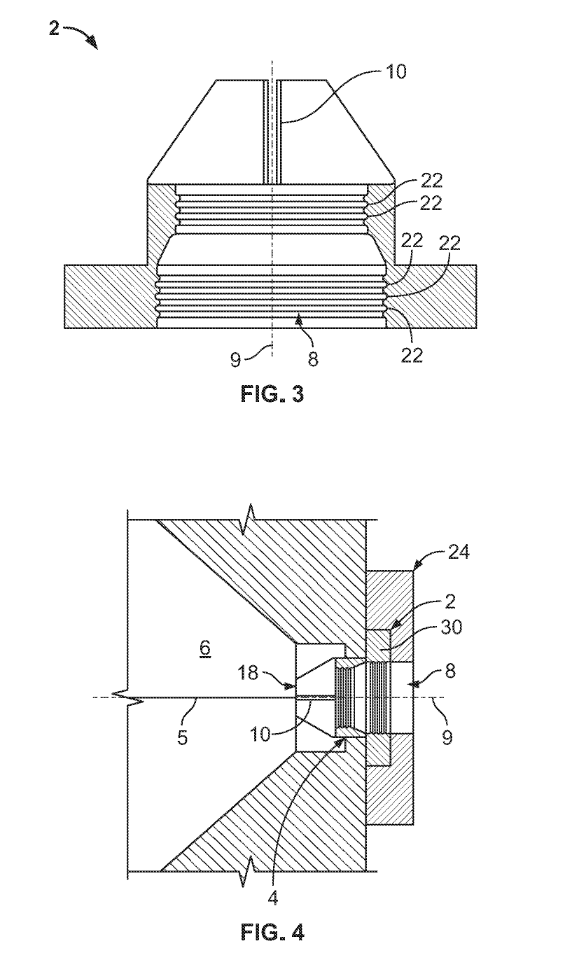

In order to facilitate the connection of a feed line (not shown) for the casting material (not shown), the stopper 2 can have a connection profile 22 (FIG. 3), which is designed to connect a casting material feed line. This profile is arranged on the end facing towards the outside of the casting mould 6 in the through-passage 8 when it is inserted into a casting mould 6 (FIG. 4). There, grooves 22 progressing circumferentially radially are designed complementary to webs (not shown) progressing circumferentially radially on a thus suitably designed tip of a mixer (not shown), which then systematically fits with this connection profile.

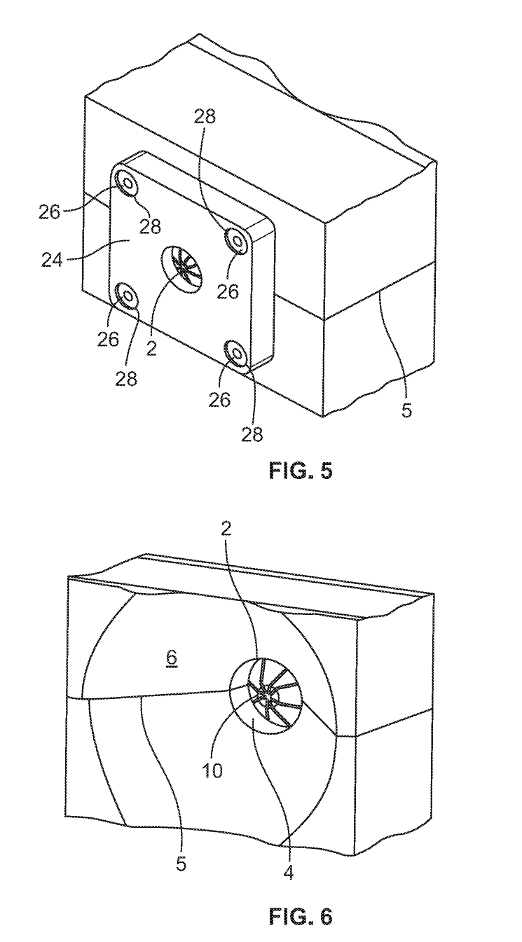

For insertion into the sprue 4 of a casting mould 6, the stopper 2 has an installation device 24 (FIGS. 4 and 5), by means of which the stopper 2 can be releasably fastened in the sprue 4 of the casting mould 6 by four screws 26. For this, the casting mould 6, for the sprue 6 of which the stopper 2 is provided, has also structures 28, namely bore holes 28, through which the casting mould 6 is adjusted for the insertion and releasable fastening of the stopper 2. The installation device 24 is a coupling collar 24 that overlaps a flange collar 30 on the stopper 2 (FIG. 4) and presses into the sprue 4 in an edge-sealing manner. The device 24 holds the stopper 2 tight and sealed in the sprue 4 along its edge but is still quickly releasable at the four screws 26.

In order to further accelerate the quick interchangeability of the stopper (for example when it is designed as a “disposable item” and is to be replaced after one or more uses), an alternative “coupling collar” (not shown) can also be hinged to the casting mould 6 by means of a hinge joint (not shown) and then only needs to be fastened in the functional position for example with one or two screws (i.e. according to the designed position of the coupling collar 24) in order to securely guarantee its pressing and holding function.

1. A stopper (2) for a sprue (4) of a casting mould (6), which has a through-passage (8) for introducing casting material into the sprue of the casting mould and which is designed such that it automatically closes the through-passage against the flow of casting material out of the casting mould.

2. The stopper according to the previous claim, characterized by a connection profile (22), which is designed in the through-passage (8) for the connection of a casting material feed line.

3. The stopper according to one of the previous claims, characterized in that the stopper has a stopper body (2) made of an elastic material, which is deformed elastically under the pressure of the casting material during introduction through the through-passage (8) into the sprue (4) of the casting mould (6) and thereby opens a closure (10) in the through-passage into the sprue.

4. The stopper according to the previous claim, characterized in that the closure (10) has a slit (10), the walls of which lie on each other in the undeformed state of the stopper body and close the through-passage (8).

5. The stopper according to the previous claim, characterized in that the slit (10) in the undeformed state of the stopper body (2) extends radially with respect to the direction of flow (9) through the through-passage through one end of the stopper body, into which the through-passage (8) flows, and extends axially (9) into the through-passage.

6. The stopper according to one of the two previous claims, characterized by one or more slits (10), which are turned towards each other around an axis (9) by the same angle.

7. The stopper according to one of the three previous claims, characterized in that the slit (10) is straight.

8. The stopper according to one of the four previous claims, characterized in that the stopper body (2) or the stopper (2) is rotationally symmetrical.

9. The stopper according to one of the previous claims, characterized by an installation device (24), by means of which the stopper (2) can be releasably fastened in the sprue (4) of the casting mould (6).

10. A method for filling a casting mould (6) with casting material, having the steps of:
inserting a stopper (2) according to one of the previous claims into a sprue (4) of a casting mould and then
introducing casting material into the through-passage (8).
